(19) United States
(12) Patent Application Publication
(10) Pub. No.: US 2006/0195447 A1
(43) Pub. Date: Aug. 31, 2006

(54) Method of browsing contents using metadata and electronic program guide system using the method

(75) Inventor: Woo-yong Chang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/361,995

(22) Filed: Feb. 27, 2006

(30) Foreign Application Priority Data
Feb. 28, 2005 (KR) 10-2005-0016397

(51) Int. Cl. G06F 17/30

(52) U.S. Cl. 707/6

(57) ABSTRACT

A method of browsing contents using metadata and an electronic program guide system using the method, the method including displaying a plurality of search options included in metadata of content currently activated and receiving a search option selected by a user; searching for contents having metadata similar to the metadata of the currently activated content; displaying found contents and activating the content selected by the user from the found contents; and repeating the displaying of the search options, receiving of the search option selected by the user, the searching of the contents, the displaying of the found contents and activating of the content selected by the user until the user finds desired contents. Accordingly, users without specific programs to view can browse desired contents easily. In addition, the method and EPG system enables a user to flexibly browse a program by reflecting changes in the user's interest during browsing.

### BACKGROUND OF THE INVENTION

This application claims the priority of Korean Patent Application No. 10-2005-

0016397, filed on Feb. 28, 2005, in the Korean Intellectual Property Office, the disclosure of which is incorporated herein in its entirety by reference.

1.Field of the Invention

The present invention relates to an electronic program guide (EPG) system, and more particularly, to a method of browsing contents using metadata and an EPG system using the method.

2. Description of the Related Art

Digital multimedia broadcasting (DMB) services include terrestrial, cable, and satellite broadcasting services and offer about 230 channels. Recently, diverse attempts have been made to enable users to select and view desired contents from various contents provided by such a variety of digital broadcasting services and other multimedia services.

A conventional electronic program guide (EPG) developed by Gemstar is one example. The EPG lists broadcasting program titles in a grid with time on one axis and a list of channels on the other axis. In other words, the EPG lists broadcasting contents by time and channel in a similar way as broadcast program information is listed in newspapers. Therefore, the EPG has an information structure that users are familiar with and enables users to easily make scheduled recordings of desired broadcasting programs using devices such as private video recorders (PVRs).

When a user has a clear viewing purpose or wants to view a specific program, the user is highly likely to view the program when it is broadcast or make a scheduled recording of the program and view it later. In this case, the user can search for a desired program without any problem. However, when the user does not have a clear viewing purpose or a specific program to view, it is difficult for the user to find a desired program since program information such as the EPG is merely data that contains time and channel information.

According to a survey on TV viewing behaviors of users, a majority of users habitually watch television and their primary purpose of watching television is for enjoyment or relaxation. Therefore, not many users have clear viewing purposes or a specific program to view. Very often, a first program viewed when the TV is switched is an indicator for finding a desired program.

However, the conventional EPG fails to use such an indicator and simply lists programs by time and channel in a matrix format. Thus, users have to search for desired programs themselves. In other words, when the conventional EPG is used, a majority of users who do not have clear viewing purposes have to spend a lot of time finding a desired program and sometimes even fail to find one. In addition, the conventional EPG fails to provide a search engine that can flexibly respond to changes in users' areas of interest.

### SUMMARY OF THE INVENTION

The present invention provides a method of browsing contents and an enhanced electronic program guide (EPG) system, both of which concern an entertainment function of television and help users without clear viewing purposes or specific programs to view, to browse desired programs easily, quickly, and enjoyably.

The present invention provides a method of browsing contents and an enhanced electronic program guide (EPG) system, which help a user to flexibly browse a program by reflecting changes in the user's interest during program browsing.

According to an aspect of the present invention, there is provided a method of browsing contents, comprising: displaying a plurality of search options included in metadata of content currently activated and receiving a search option selected by a user; searching for contents having metadata similar to the metadata of the currently activated content; displaying found contents and activating the content selected by the user from the found contents; and repeating the displaying of the search options and receiving of the search option selected by the user, the searching of the contents, and the displaying of the found contents and activating of the content selected by the user until the user finds desired contents.

The method may further include reproducing the activated content after the displaying of the found contents and activating of the content selected by the user.

The method may further include scheduling a viewing of the activated content after the displaying of the found contents and activating of the content selected by the user.

The method may further include scheduling a recording of the activated content after the displaying of the found contents and activating of the content selected by the user.

The search options may include director, actor, genre, time, or a combination of director, actor, genre, and time.

In the searching of the contents, whether metadata of contents is similar to the metadata of the currently activated content may be determined by whether the metadata of the contents has a same search option as the metadata of the currently activated content.

In the searching of the contents, whether the metadata of the contents is similar to the metadata of the currently activated content may be determined according to an order of priority of search options predetermined as default search options.

According to another aspect of the present invention, there is provided a method of browsing contents, comprising: displaying a plurality of search options included in metadata of content currently activated and receiving a search option selected by a user; searching for contents having metadata similar to the metadata of the currently activated content; displaying found contents and activating the content selected by the user from the found contents; and terminating a contents search or proceeding to the displaying of the search options and receiving of the search option selected by the user, according to whether the user decides to terminate or continue the contents search.

According to another aspect of the present invention, there is provided an electronic program guide system for browsing contents, comprising: a user interface displaying a plurality of search options included in metadata of content currently activated, receiving a search option selected by a user, displaying found contents, and activating content selected by the user from the displayed contents; and a search unit searching for contents having metadata similar to the metadata of the currently activated content using the selected search option and transmitting the search result to the user interface, wherein the electronic program guide system repeats a contents search until the user finds desired contents while changing search options and contents to be activated according to changes in the user's interest.

The system may further include a control unit controlling a reproducing/recording apparatus to reproduce the activated content.

The system may further include a control unit controlling the reproducing/recording apparatus to schedule a viewing of the activated contents.

The system may further include a control unit controlling the reproducing/recording apparatus to schedule a recording of the activated contents

### BRIEF DESCRIPTION OF THE DRAWINGS

The above and other features and advantages of the present invention will become more apparent by describing in detail non-limiting, exemplary embodiments thereof with reference to the attached drawings in which:

FIG. 1 illustrates an EPG system using a method of browsing contents using metadata according to a non-limiting embodiment of the present invention;

FIG. 2 illustrates a menu structure for browsing contents according to a non-limiting embodiment of the present invention;

FIG. 3 illustrates an example of an initial screen illustrated in FIG. 2;

FIG. 4 illustrates an example of a search screen illustrated in FIG. 2;

FIG. 5 illustrates the search screen displayed when a user intends to change search options to browse contents;

FIG. 6 illustrates an example of a scheduling screen displayed when a user intends to schedule a viewing of contents found according to the present invention;

FIG. 7 illustrates an example of the scheduling screen displayed when a user intends to schedule a recording of contents found according to the present invention;

FIGS. 8 through 10 illustrate examples of contents search models using metadata according to the present invention;

FIG. 11 is a flowchart illustrating a method of browsing contents using metadata according to a non-limiting, exemplary embodiment of the present invention; and

FIGS. 12A through 12F are examples of screens illustrating a process of browsing contents using metadata according to the present invention.

### DETAILED DESCRIPTION OF THE INVENTION

The present invention will now be described more fully with reference to the accompanying drawings, in which non-limiting, exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

The present invention provides a method of browsing contents such as broadcasting programs or movies using metadata, and an electronic program guide (EPG) system using the method. In other words, in the present invention, the metadata included in the contents is used to search for contents desired by a user. The metadata may include information regarding various search options such as scene, director, actor, genre, item, soundtrack, and location.

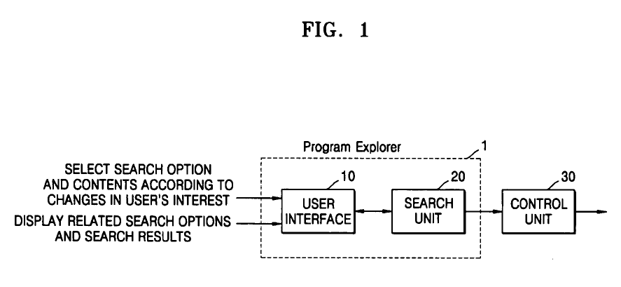

FIG. 1 illustrates an EPG system using a method of browsing contents using metadata according to an embodiment of the present invention. Referring to FIG. 1, the EPG system includes a program explorer 1 and a control unit 30, such as a computer. The program explorer 1 includes a user interface 10 and a search unit 20.

The user interface 10 displays a plurality of search options related to content currently activated and search results for a search option selected from the search options. In addition, the user interface 10 receives information regarding the selection of a search option by a user according to a change in the user's interest and the selection of content from search results for the search option. The search option refers to a search keyword such as director, actor, genre, time, or a combination of them, and the search option is included in the metadata of the contents.

The search unit 20 searches for contents having metadata similar to metadata included in content currently activated using a selected search option and transmits search results for the selected search option to the user interface 10 to display them.

The control unit 30 controls a reproducing/recording unit (not shown) to reproduce contents selected by the user from found contents or to schedule a viewing or recording of the selected contents.

The operation of the EPG system according to the present invention will now be described. When a user selects a program explorer function in the user interface 10 while viewing contents, the user interface 10 displays search options related to the content currently activated to facilitate browsing of the contents by the user. When the user selects a search option from the displayed search options, the selected search option is transmitted to the search unit 20. The search unit 20 searches for contents using the received search option and transmits search results to the user interface 10, which then displays the search results. If the user finds desired contents from the search results, the user may reproduce, or schedule a viewing or recording of the desired contents using the control unit 30. Then, the browsing is terminated.

However, if the user wants to continue browsing the contents, the EPG system displays search options related to content activated by the user and repeats a content search operation described above while changing search options according to changes in the user's interest. In other words, the EPG system according to the present invention can continue searching contents while adaptively changing search options according to changes in a user's interest.

Accordingly, the EPG system helps the user not only to browse desired contents quickly and easily but also to find unexpected contents. Further, the EPG system can flexibly adapt to changes in the user's interest during content browsing, thereby facilitating the browsing of the contents by the user.

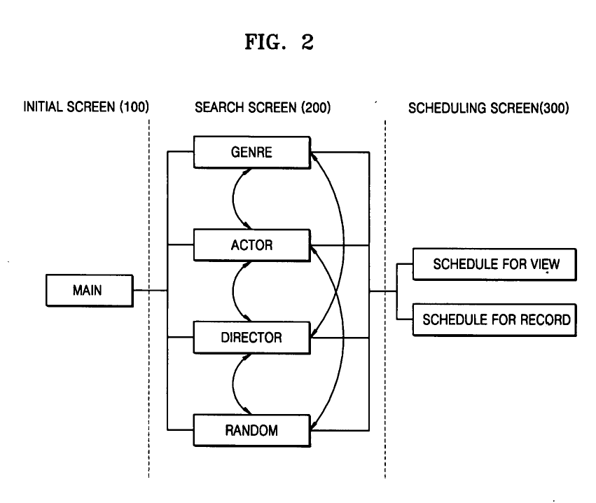

A method of browsing contents according to the present invention will now be described in detail. FIG. 2 illustrates a menu structure for browsing contents according to an embodiment of the present invention.

Referring to FIG. 2, a structure of a menu screen provided by the user interface 10 described above is illustrated to describe a method of browsing contents using metadata according to the present invention. The menu screen is divided into an initial screen 100, a search screen 200, and a scheduling screen 300.

The initial screen 100 is a menu screen that first appears when the program explorer 1 is initiated. Four search options related to contents currently activated, such as director, actor, genre, time, or a combination of them, are displayed on the initial screen 100. Additionally, item, soundtrack, or location may be used. A user may select one of the search options displayed on the initial screen 100.

When the user selects a search option of his or her interest from the displayed search options, the program explorer 1 searches for contents using the selected search option. For example, the program explorer 1 searches for other contents directed by a director of content currently activated, other contents in which an actor of the currently activated content stars, other contents in the same genre as the currently activated content, or other contents broadcast at the same time as the currently activated content.

The search screen 200 displays search results for a search option selected by the user. For example, when the user selects the search option “director,” metadata information regarding other contents directed by a director of the content currently activated is displayed. In particular, in the present invention, content searching may be performed more than once. The EPG system repeats a search of contents while changing search options according to changes in the user's interest until contents desired by the user are found. As indicated by various arrows between search options, it is possible to switch from a selected search option to any other search option a number of times. In other words, a nonlinear search structure in which search options can be freely changed is provided.

The scheduling screen 300 is where the user can schedule a viewing or recording of contents found. The scheduling screen 300 shows a list of programs that the user has scheduled to view or record.

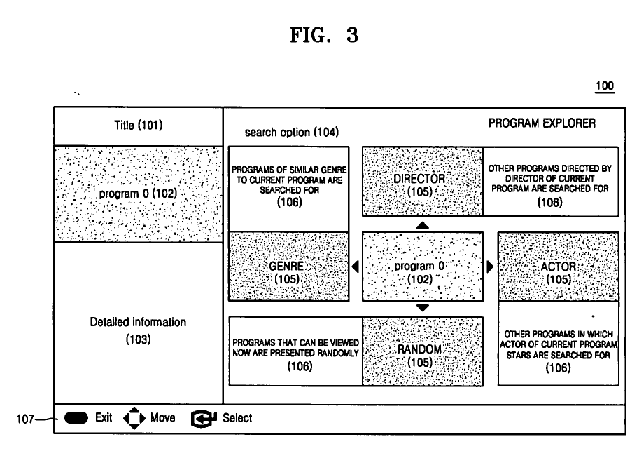

The initial screen 100, the search screen 200, and the scheduling screen 300 will now be described in more detail. FIG. 3 illustrates an example of the initial screen 100 illustrated in FIG. 2.

Referring to FIG. 3, reference numeral 101 indicates a title of content currently activated, reference numeral 102 indicates a screen of the currently activated content, and reference numeral 103 indicates detailed information included in metadata of the content currently activated and reproduced. For example, the detailed information 103 may include information regarding director, actor, genre, rating, screen time, year of production, country of origin, and plot.

Reference numeral 104 indicates selected search options, and reference numeral 105 indicates search options related to the currently activated content. Director, actor, genre, and random are illustrated as examples of the search options 105. Reference numeral 106 indicates additional information regarding the search options 105. For example, if the search option “director” is selected, other programs directed by a director of a program currently being reproduced are searched for, if the search option “actor” is selected, other programs in which an actor of a program currently being reproduced stars are searched for, if the search option “genre” is selected, other programs of a similar genre to the currently reproduced program are searched for, and if the search option “random” is selected, other programs that can be viewed now are randomly searched for.

Reference numeral 107 indicates various keys that can be used on a current screen to input selection information. Move (four directions), Select, and Exit keys are illustrated as examples of the keys used for selecting the search options 105. The user may select a search option of his or her interest using such keys included in the user interface 10. An example of the user interface 10 is a remote controller.

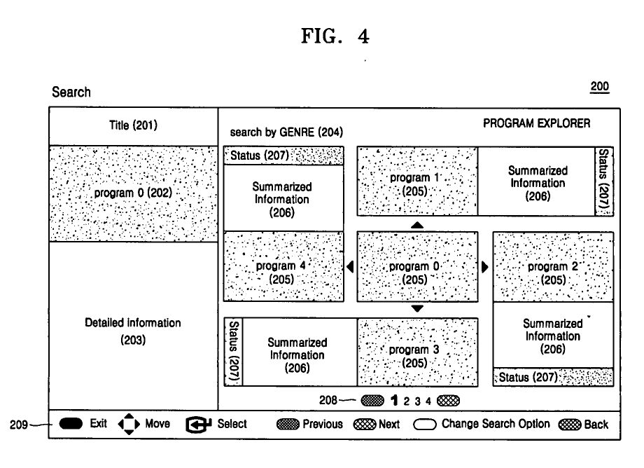

FIG. 4 illustrates an example of the search screen 200 illustrated in FIG. 2. Referring to FIG. 4, reference numerals 201 through 204 indicate elements identical to those indicated by reference numerals 101 through 104 in FIG. 3 and thus their description will be omitted. Reference numeral 205 indicates search results for a search option selected on the initial screen 100 of FIG. 3. A screen, a representative image, or a title of a program found may be displayed on the search screen 200. Reference numeral 206 indicates summarized information of the found program. The summarized information 206 may include information such as title, director, actor, genre, transmission rate, and screen time according to embodiments of the present invention and is included in the metadata of the contents.

Reference numeral 207 indicates a status of the found program. In other words, the status 207 may provide information regarding whether the found program can be viewed now, today, or in the future. Reference numeral 208 indicates the number of search result pages, and reference numeral 209 indicates keys included in the user interface 10, which can be used on a current screen. In particular, a Change Search Option key is used to change search options when a user is not satisfied with current search results and wants to continue browsing the contents while changing the search options.

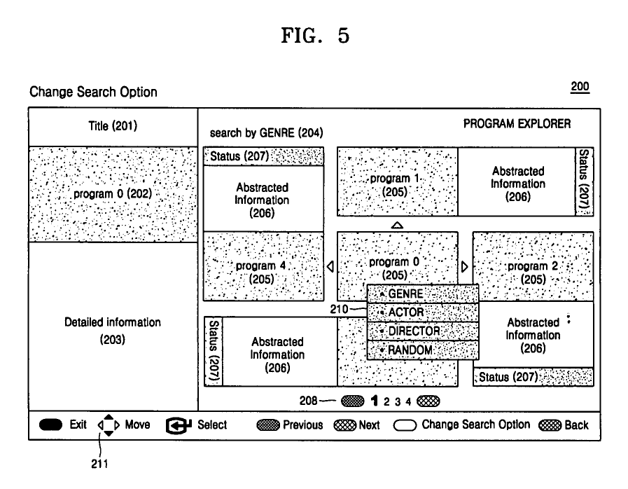

After the user presses the Change Search option key in the user interface 10, the search screen 200 of FIG. 5 is displayed. FIG. 5 illustrates the search screen 200 displayed when a user intends to change the search options to browse the contents. Referring to FIG. 5, a list of search options that can be changed 210 is displayed. The user may arbitrarily select a search option from the list of search options to change a search option. For the user's convenience, of four directions of the Move key, only those that can be used now may be activated and displayed as indicated by reference numeral 211. The user may continue to browse contents until the user finds desired contents while changing search options by pressing the Change Search Option key.

If the user finds the desired contents, the user may reproduce, or schedule a viewing or recording of the desired contents using the control unit 30. Then, the content browsing is terminated.

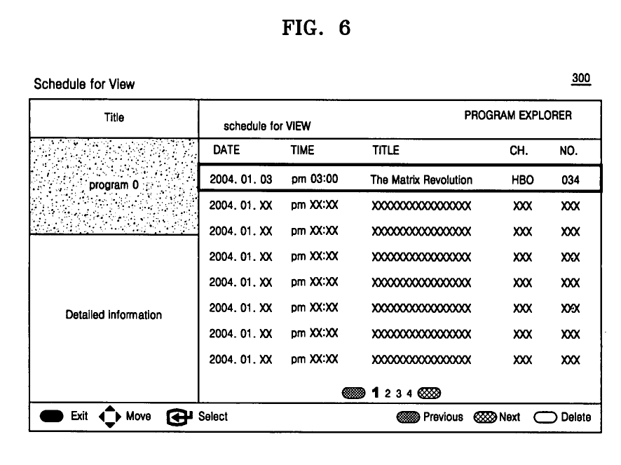

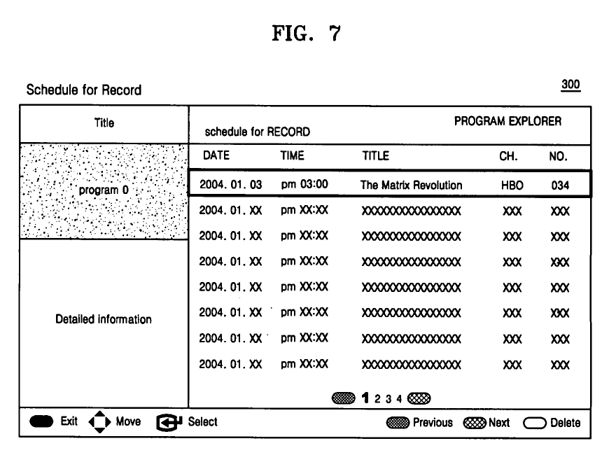

As described in FIG. 4, the status of the found program 207, i.e., contents may provide information regarding whether the found program can be viewed now, later today, or in the future. If the contents can only be viewed later today or in the future, the user may schedule a viewing or recording of the program. The scheduling screen 300 for scheduling the viewing or recording of the program is illustrated in FIGS. 6 and 7.

FIG. 6 illustrates an example of the scheduling screen 300 displayed when the user intends to schedule a viewing of contents found according to the present invention. FIG. 7 illustrates an example of the scheduling screen 300 displayed when the user intends to schedule a recording of contents found according to the present invention.

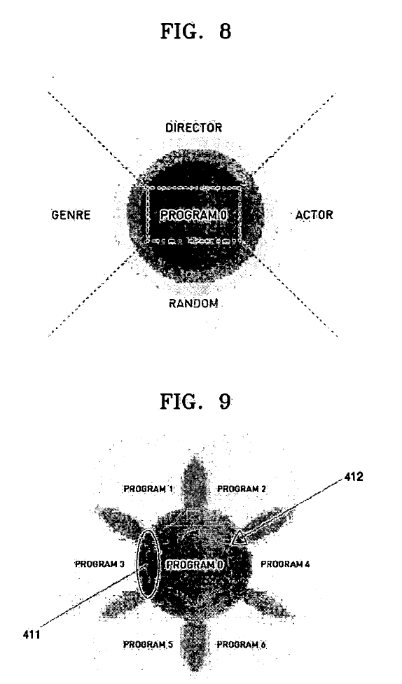

FIGS. 8 through 10 illustrate examples of content search models using metadata according to the present invention. Referring to FIG. 8, search options for browsing contents related to program 0, i.e., content currently activated, are displayed. In other words, director, actor, genre, and random may be used as search options. By selecting one of the search options related to the currently activated content, other contents directed by a director of the currently activated content, other contents in which an actor of the currently activated content stars, other contents of the same genre as the currently activated content, or other contents broadcast at the same time as the currently activated content can be searched.

Accordingly, when the method of browsing contents according to the present invention is used, even those users without clear viewing purposes or specific programs to view can browse desired contents easily and quickly.

Referring to FIG. 9, various contents related to the currently activated content can be browsed using common search options, that is, common properties of a plurality of contents such as indicated by reference numerals 411 and 412. In other words, the scope of content browsing can be expanded into other programs having at least one of search options such as director, actor, genre, and random as common properties shared with program 0, which is a program currently activated. Further, more diverse programs having at least one search option as common properties shared with the currently activated program can be browsed while changing activated programs or search options according to changes in the user's interest. In other words, by using common properties among programs, the scope of content browsing can be expanded in a nonlinear manner.

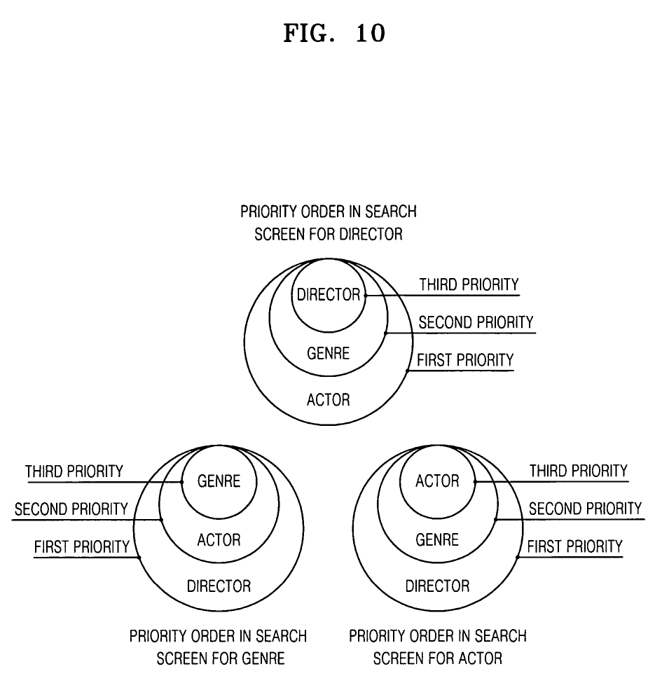

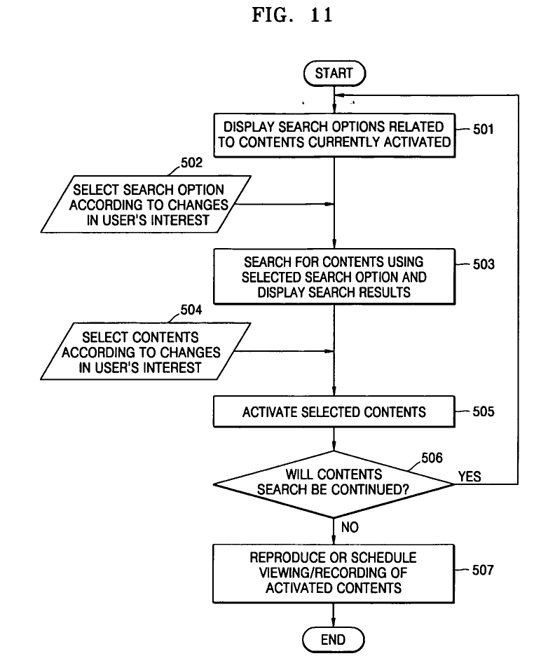

Referring to FIG. 10, search options may be prioritized. Thus, when a user does not select a search option, a default search option may be designated and search results for the default search option may be listed. Accordingly, even those users without clear viewing purposes can easily browse various contents with minimum selection. In addition, contents sharing the same search option may be listed in order of screen time.

FIG. 11 is a flowchart illustrating a method of browsing contents using metadata according to an examplary embodiment of the present invention. Referring to FIG. 11, a plurality of search options related to content currently activated are displayed (operation 501). A user selects a search option of his or her interest (operation 502). As described above, director, actor, genre, random, or various search information included in metadata may be selected as a search option. Based on the selected search option, contents are searched for and search results are displayed (operation 503). When the user selects one of the search results, i.e., contents (operation 504), the selected content is activated (operation 505).

If the activated content is what the user desires (operation 506), content browsing is terminated, and the activated content is reproduced or a viewing or recording of the activated content is scheduled (operation 507). However, if the user wishes to continue browsing the contents (operation 506), content browsing operations described above (operations 501 through 505) are repeated based on contents newly activated. The contents browsing operations may be repeated a plurality of times until the user finds desired contents. The EPG system may continue to browse the contents while changing search options or activated contents according to changes in the user's interest.

Hence, unlike a conventional method of searching for programs by simply switching between channels or searching for programs according to fixed criteria, the method according to the present invention provides a user with an environment where the user can actively browse a desired program. Also, while the conventional EPG allows a user to browse only a desired program, the EPG system according to the present invention provides an intelligent browsing environment where the user can find a program that the user did not expect. Further, the method according to the present invention offers the user with an environment in which the user can browse programs more flexibly by changing search options according to changes in his or her interest.

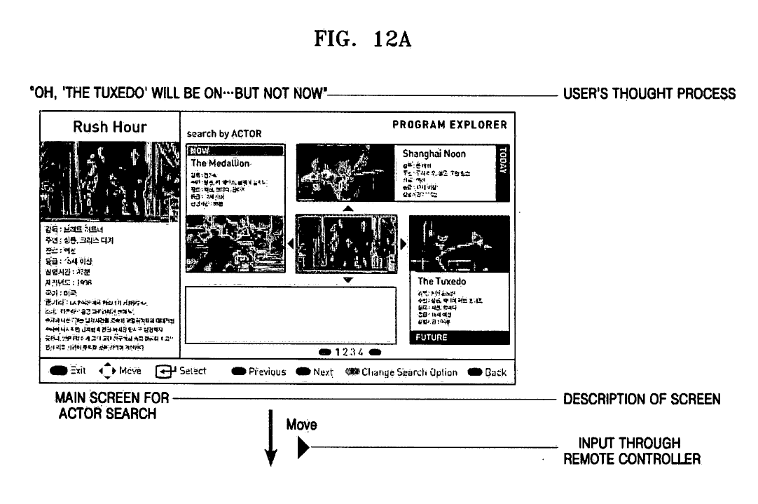

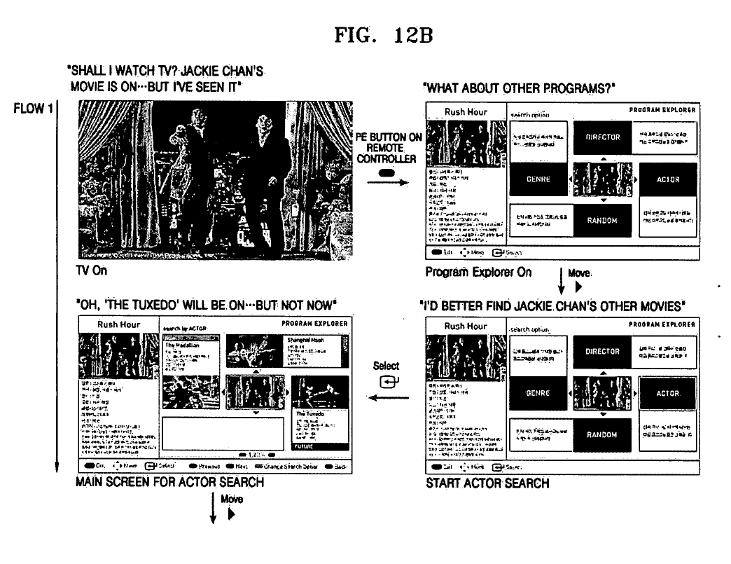

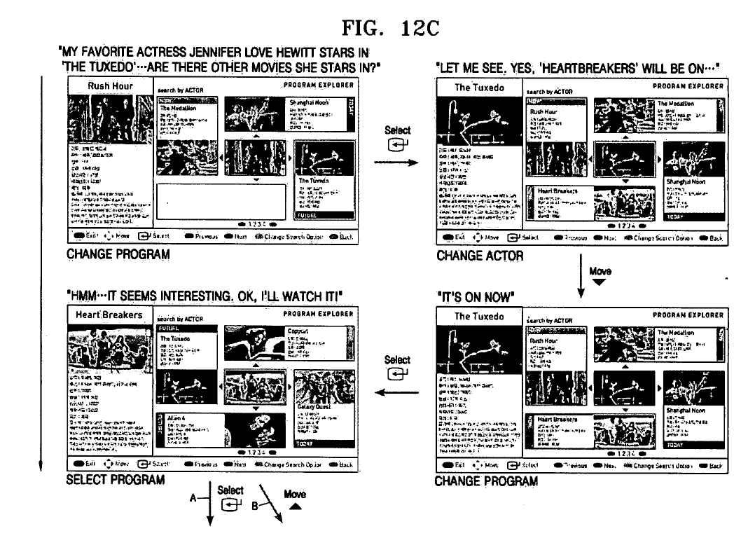

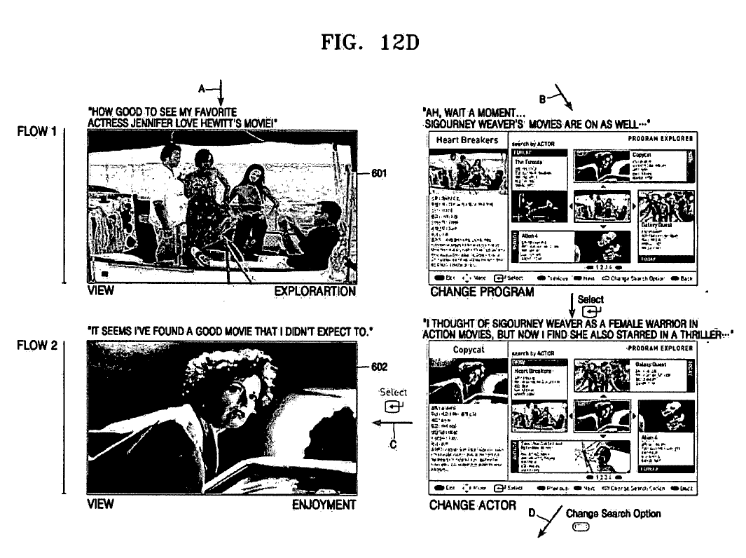

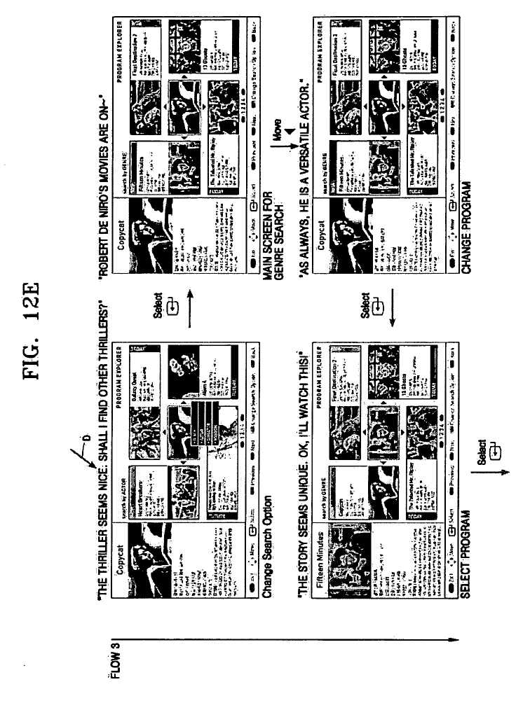

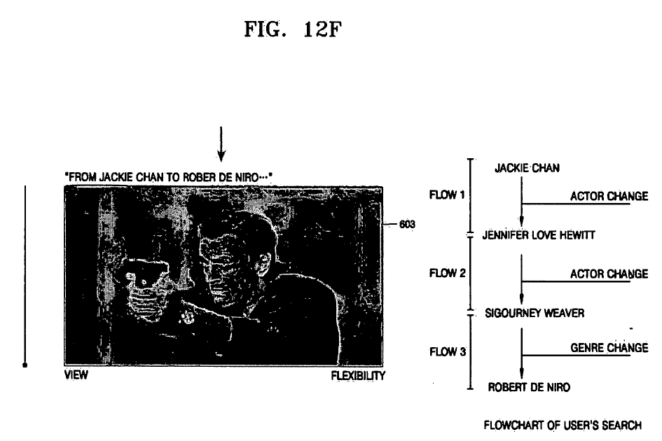

An application of the method of browsing contents according to the present invention will now be described. FIG. 12A is a screen illustrating how to use screens in FIGS. 12B through 12F. A thought process of a user is expressed above the screen, and a description of the screen is made below the screen. An arrow below the screen indicates information regarding a user's selection made by using the user interface 10 such as a remote controller. A process by which the user searches for a desired program after turning on the television is indicated by FLOW 1 (FIGS. 12B through 12D), a process by which the user finds an unexpected program and views the unexpected program is indicated by FLOW 2 (FIG. 12D), and a process by which the user browses programs while changing search options and views a found program is indicated by FLOW 3 (FIGS. 12E and 12F).

FIGS. 12B through 12F are examples of screens for illustrating a process of browsing contents using metadata according to the present invention. Referring to FIG. 12B, when a user turns on the television, content currently activated and reproduced is displayed (upper left). When the user presses a program explorer (PE) button included in a remote controller to browse the contents, the initial screen 100 is displayed (upper right). In other words, when the program explorer 1 is initiated, the initial screen 100 including content currently activated and search options related to the currently activated content are displayed. The user may navigate to a search option “actor” using a Move key included in the remote controller and press a Select key (lower right). Then, other contents in which an actor of the currently activated content stars are searched for and displayed (lower left).

Referring to FIG. 12C, when the user selects content of his or her interest from search results displayed (upper left), the selected content is activated and contents related to the activated content are searched for and displayed (upper right). A search option used in this process may be designated as a default search option as described with reference to FIG. 10. When the user selects content from the displayed search results (lower right), the newly selected content is activated and contents related to the newly activated content are displayed (lower left).

Referring to FIG. 12D, if the user finds desired content 601 from the displayed search results (case A), the user may select and reproduce the desired content 601 (upper left). However, if the user wishes to continue browsing contents (case B), the user may continue to browse contents while changing content currently activated (upper right) or search options (lower right). In this process, if the user finds desired content 602 (case C) from search results, the user may select and reproduce the desired content 602 (lower left).

Referring to FIG. 12E, if the user wishes to continue browsing contents (case D), the user can continue to browse desired contents by changing search options such as genre, actor, or director, or changing activated contents.

FIG. 12F illustrates a case where the user finds and reproduces desired content after repeating the process of browsing the contents a plurality of times. As illustrated in the right side of FIG. 12F, the browsing process starts at contents in which Jackie Chan stars. As the user's interest changes, the process proceeds to Jennifer Love Hewitt and Sigourney Weaver and ends when contents in which Robert De Niro stars are finally found. The user may continue to browse contents until the user finds desired contents while changing search options or activated contents according to changes in the user's interest.

As described above, the present invention provides a method of browsing contents using metadata and an EPG system using the method. Hence, unlike a conventional method of searching for programs by simply switching between channels or searching for programs according to fixed criteria, the method and the EPG system according to the present invention provide a user with an environment where the user can actively browse a desired program. Also, while the conventional EPG allows a user to browse only a desired program, the EPG system according to the present invention provides an intelligent browsing environment where the user can find a program that the user did not expect. Further, the method and the EPG system according to the present invention offer a user with an environment where the user can browse programs more flexibly by changing search options according to changes in his or her interest.

The present invention can also be implemented as a computer program. Codes and code segments constituting the computer program can be easily construed by programmers skilled in the art to which the present invention pertains.

Also, the computer program is recorded on a computer-readable recording medium and thereafter read by a computer system. Examples of the computer-readable recording medium include magnetic tapes, floppy disks, optical data storage devices, and carrier waves.

While the present invention has been particularly shown and described with reference to non-limiting, exemplary embodiments thereof, it will be understood by those of ordinary skill in the art that various changes in form and details may be made therein without departing from the spirit and scope of the present invention as defined by the following claims.

What is claimed is:

1. A method of browsing contents, comprising:
displaying a plurality of search options included in metadata of content currently activated and receiving a search option selected by a user;
searching for contents having metadata similar to the metadata of the currently activated content;
displaying found contents and activating a content selected by the user from the found contents; and
repeating the displaying of the search options and receiving of the search option selected by the user, the searching of the contents, and the displaying of the found contents and activating of the content selected by the user until the user finds desired contents.

2. The method of claim 1, further comprising reproducing the activated content after the displaying of the found contents and activating of the content selected by the user.

3. The method of claim 1, further comprising scheduling a viewing of the activated content after the displaying of the found contents and activating of the content selected by the user.

4. The method of claim 1, further comprising scheduling a recording of the activated content after the displaying of the found contents and activating of the content selected by the user.

5. The method of claim 1, wherein the search options comprise at least one of director, actor, genre, and time.

6. The method of claim 1, wherein, in the searching of the contents, whether metadata of contents is similar to the metadata of the currently activated content is determined by whether the metadata of the contents has a same search option as the metadata of the currently activated content.

7. The method of claim 1, wherein, in the searching of the contents, whether the metadata of the contents is similar to the metadata of the currently activated content is determined according to an order of priority of search options predetermined as default search options.

8. A method of browsing contents, comprising:
displaying a plurality of search options included in metadata of content currently activated and receiving a search option selected by a user;
searching for contents having metadata similar to the metadata of the currently activated content;
displaying found contents and activating a content selected by the user from the found contents; and
terminating the contents search or proceeding to the displaying of the search options and receiving of the search option selected by the user, according to whether the user decides to terminate or continue the contents search.

9. The method of claim 8, further comprising reproducing the activated content after the termination of the contents search.

10. The method of claim 8, further comprising scheduling a viewing of the activated content after the termination of the contents search.

11. The method of claim 8, further comprising scheduling a recording of the activated content after the termination of the contents search.

12. The method of claim 8, wherein the search options comprise at least one of director, actor, genre, and time.

13. The method of claim 8, wherein, in the searching of the contents, whether metadata of contents is similar to the metadata of the currently activated content is determined by whether the metadata of the contents has a same search option as the metadata of the currently activated content.

14. The method of claim 8, wherein, in the searching of the contents, whether the metadata of the contents is similar to the metadata of the currently activated content is determined by an order of priority of search options predetermined as default search options.

15. An electronic program guide system for browsing contents, comprising:
a user interface operative to display a plurality of search options included in metadata of content currently activated, to receive a search option selected by a user, to display found contents, and to activate content selected by the user from the displayed contents; and
a search unit operative to search for contents having metadata similar to the metadata of the currently activated content using the selected search option and to transmit the search result to the user interface,
wherein the electronic program guide system repeats a contents search until the user finds desired contents while changing the search options and contents to be activated according to changes in the user's interest.

16. The system of claim 15, further comprising a control unit operative to control a reproducing and recording apparatus to reproduce the activated content.

17. The system of claim 15, further comprising a control unit operative to control a reproducing and recording apparatus to schedule a viewing of the activated content.

18. The system of claim 15, further comprising a control unit operative to control a reproducing and recording apparatus to schedule a recording of the activated content.

19. The system of claim 15, wherein the search options comprise at least one of director, actor, genre, and time.

20. The system of claim 15, wherein the search unit determines whether the metadata of the contents has a same search option as the metadata of the currently activated content to determine whether metadata of contents is similar to the metadata of the currently activated content.

21. The system of claim 15, wherein the search unit determines whether the metadata of the contents is similar to the metadata of the currently activated content based on an order of priority of search options predetermined as default search options.

22. A computer readable recording medium having embodied thereon a computer program for executing a method of browsing contents, the method comprising:
displaying a plurality of search options included in metadata of content currently activated and receiving a search option selected by a user;
searching for contents having metadata similar to the metadata of the currently activated content;
displaying found contents and activating a content selected by the user from the found contents; and
repeating the displaying of the search options and receiving of the search option selected by the user, the searching of the contents, and the displaying of the found contents and activating of the content selected by the user until the user finds desired contents.

23. A computer readable recording medium having embodied thereon a computer program for executing a method of browsing contents, the method comprising:
displaying a plurality of search options included in metadata of content currently activated and receiving a search option selected by a user;
searching for contents having metadata similar to the metadata of the currently activated content;
displaying found contents and activating a content selected by the user from the found contents; and
terminating the contents search or proceeding to the displaying of the search options and receiving of the search option selected by the user, according to whether the user decides to terminate or continue the contents search.
